(19) United States
(12) Patent Application Publication
(10) Pub. No.: US 2002/0141169 A1
(43) Pub. Date: Oct. 3, 2002

(54) Electronic apparatus having a plurality of printed board layers

(76) Inventor: Satoshi Matsushita, Ome-shi (JP)

Correspondence Address: Pillsbury Winthrop LLP, Suite 2800, 725 South Figueroa Street, Los Angeles, CA, 90017-5406, US

(21) Appl. No.: 10/104,346

(22) Filed: Mar. 22, 2002

(30) Foreign Application Priority Data
Mar. 30, 2001 (JP) 2001-101336

(51) Int. Cl. H01R 12/16

(52) U.S. Cl. 361/786

(57) ABSTRACT

A printed board apparatus is assembled by superposing two printed boards spaced by a gap. A connector is disposed on a lower printed board. A through hole is formed across the connector in an upper printed board. A harness is passed through the through hole and connected to the connector.

### CROSS-REFERENCE TO RELATED APPLICATIONS

This application is based upon and claims the benefit of priority from prior Japanese Patent Application No. 2001-101336, filed Mar. 30, 2001.

### BACKGROUND OF THE INVENTION

1. Field of the Invention

The present invention relates to a printed board assembly incorporated, for example, in a housing of an electronic apparatus, and an electronic apparatus in which a plurality of printed boards are superposed upon one another and attached in a housing.

2. Description of the Related Art

Small-sized electronic apparatuses superior in portability, such as a notebook-size personal computer (notebook-size PC) are known. In a housing of the electronic apparatus, a battery and electronic circuits are attached, and a printed board with a large number of electronic components mounted thereon with a high density is incorporated.

Usually, two or three printed boards are superposed upon one another to form a printed board assembly, a space occupied by the printed boards is set to be as small as possible, and the electronic apparatus is miniaturized.

However, as shown in FIG. 4, in a conventional printed board assembly constituted by superposing two printed boards 1a, 1b via a gap 2, in order to pass a harness 5 for electrically connecting electronic components 3 mounted on the printed board 1a to external electronic components or apparatuses (not shown) through the gap 2 from a side portion of the printed board 1a and to connect the harness 5 to a connector 4, the gap 2 between the printed boards 1a, 1b needs to be broadened to secure a space for drawing in the harness 5.

Therefore, there is a problem that the space occupied by the printed board assembly is enlarged and that the electronic apparatus is enlarged in size.

Moreover, in order to facilitate a connection operation of the connector 4, it is necessary to dispose the connector 4 in the vicinity of a peripheral edge of the printed board 1a, and a problem exists in that mounting positions of the connector 4 and electronic component 3 are restricted.

Furthermore, because the harness 5 needs to be extended along the upper surface of the printed board 1a with the electronic components 3 mounted thereon, a mounting layout of the other electronic components disposed in a path of the harness 5 is disadvantageously restricted.

Additionally, in a manufacturing process of the printed board assembly, after the harness 5 is connected to the connector 4 of the printed board 1a, the other printed board 1b needs to be attached, and another problem is that an assembling order is also restricted.

### BRIEF SUMMARY OF THE INVENTION

An object of the present invention is to provide a printed board assembly whose occupying space can be reduced and which can easily be assembled, and an electronic apparatus including the printed board assembly.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view showing a printed board assembly according to a first embodiment of the present invention;

FIG. 2 is a sectional view showing the printed board assembly according to a second embodiment of the present invention;

FIG. 3 is a sectional view showing the printed board assembly according to a third embodiment of the present invention;

FIG. 4 is a sectional view showing a conventional printed board assembly according to the prior art; and

FIG. 5 is a block diagram showing an electronic apparatus according to an embodiment of the present invention.

### DETAILED DESCRIPTION

Embodiments of the present invention will be described hereinafter with reference to the drawings.

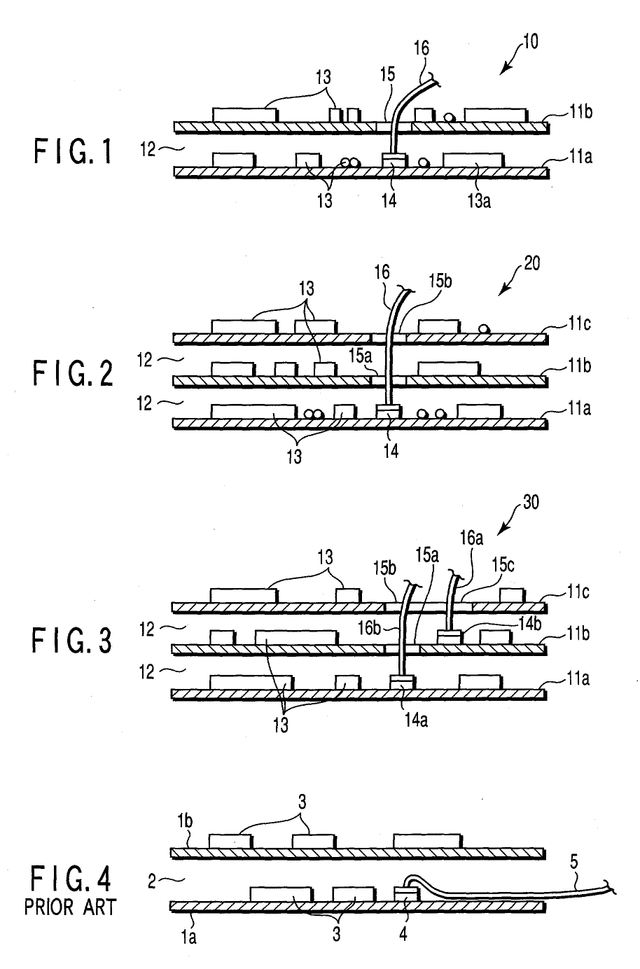

FIG. 1 shows a sectional view of a printed board assembly 10 according to a first embodiment of the present invention.

The printed board assembly 10 is assembled by vertically superposing two printed boards 11a, 11b upon each other via a constant gap 12. Electronic circuits are printed/wired and a large number of electronic components 13 are mounted on upper surfaces of the printed boards 11a, 11b. The electronic components 13 may include a Bluetooth module 13a or a wireless LAN module 13a.

In addition to the electronic components 13, a connector 14 is disposed on an upper surface of the lower printed board 11a disposed opposite to the upper printed board 11b. A harness 16 for electrically connecting the connector to a not-shown external electronic component or apparatus (hereinafter referred to as an external apparatus) is connected to the connector 14.

In the upper printed board 11b, a through hole 15 is formed in a position disposed opposite to the connector 14. One or a plurality of harnesses 16 are passed through the through hole 15, and the through hole is formed in a position such that printed wires and electronic components 13 disposed on the upper printed board 11b are avoided.

Therefore, when the printed board assembly 10 is assembled, first, two printed boards 11a, 11b are superposed upon each other via the gap 12, and the harness 16 is passed through the through hole 15 from the upper surface of the upper printed board 11b, and connected to the connector 14 disposed on the lower printed board 11a.

As described above, different from the conventional printed board assembly shown in FIG. 4, according to the present embodiment, it is unnecessary to draw the harness 16 into the gap 12 through the side portion of the printed board 11a, and the gap 12 can remarkably be narrowed. Thereby, the occupying space of the printed board assembly 10 can be reduced, and the electronic apparatus can be miniaturized.

Moreover, after the two printed boards 11a, 11b are superposed upon each other, the harness 16 can be connected to the connector 14, and the printed board assembly 10 can easily be assembled.

Furthermore, different from the conventional printed board assembly, it is unnecessary to draw the harness 16 on the upper surface of the printed board 11a, and a mounting layout of the electronic components 13 is not restricted.

Particularly, when the harness 16 connects a Bluetooth module 13a or a wireless LAN module 13a to the external apparatus, the wiring structure of the present embodiment is effective. That is, a high-frequency signal of a GHz band can efficiently be transmitted under restricted impedance conditions on the printed board 11a without any loss and without influencing the other circuits.

Additionally, since the harness 16 extends substantially straight from the connector 14, stresses applied to the harness 16 and connector 14 can be reduced.

FIG. 2 shows a sectional view of a printed board assembly 20 according to a second embodiment of the present invention. Additionally, here, constituting elements which function similarly as those of the first embodiment are denoted with the same reference numerals, and description thereof is omitted.

The printed board assembly 20 is assembled by superposing lower, middle, and upper printed boards 11a, 11b, 11c upon one another via the gaps 12.

In addition to the electronic components 13, the connector 14 is disposed on an upper surface of the lower printed board 11a disposed opposite to the middle printed board 11b. Moreover, in the middle and upper printed boards 11b, 11c, through holes 15a, 15b are formed in positions disposed opposite to the connector 14.

Therefore, when the printed board assembly 20 is assembled, three printed boards 11a, 11b, 11c are superposed upon one another via the gaps 12, and the harness 16 is passed through the through hole 15b from above the upper printed board 11c, further passed through the through hole 15a of the middle printed board 11b, and connected to the connector 14 disposed on the lower printed board 11a.

Therefore, also in the present embodiment, actions and effects similar to those of the first embodiment can be produced. Additionally, the present invention is not limited to the printed board assembly constituted by superposing three printed boards upon one another, and can also be applied to a printed board assembly constituted by superposing four or more printed boards upon one another.

FIG. 3 shows a sectional view of a printed board assembly 30 according to a third embodiment of the present invention. Additionally, here, the constituting elements which function similarly as those of the first and second embodiments are denoted with the same reference numerals, and the description thereof is omitted.

The printed board assembly 30 is assembled by superposing lower, middle, and upper printed boards 11a, 11b, 11c upon one another via the gaps 12.

A connector 14a is disposed on the upper surface of the lower printed board 11a. Moreover, on the upper surface of the middle printed board 11b disposed opposite to the upper printed board 11c, in addition to the electronic components, a connector 14b is disposed in a position deviating from that of the connector 14a. The respective connectors 14a, 14b are connected to harnesses 16b, 16a for connecting the connectors to external apparatuses (not shown).

In the middle printed board 11b, the through hole 15a is formed opposite to the connector 14a disposed on the upper surface of the lower printed board 11a. Moreover, in the upper printed board 11c, the through hole 15b is formed opposite to the through hole 15a of the middle printed board 11b, and a through hole 15c is formed opposite to the connector 14b disposed on the middle printed board 11b. In the present embodiment, the through holes 15b, 15c are connected to each other.

Therefore, when the printed board assembly 30 is assembled, first the three printed boards 11a, 11b, 11c are superposed upon one another via the gaps 12. Moreover, the harness 16a is passed through the through hole 15c from above the upper printed board 11c, and connected to the connector 14b of the middle printed board 11b. Furthermore, the harness 16b is passed through the through hole 15b from above the upper printed board 11c, further passed through the through hole 15a of the middle printed board 11b, and connected to the connector 14a disposed on the lower printed board 11a.

Therefore, also in the present embodiment, the actions and effects similar to those of the first and second embodiments can be produced.

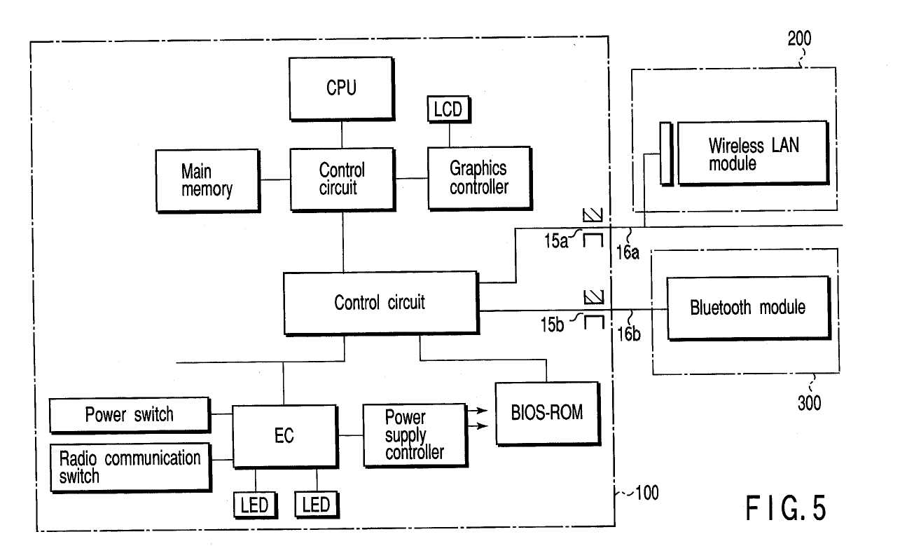

FIG. 5 shows a block diagram of an electronic apparatus according to the embodiment of the present invention. The electronic apparatus includes a main substrate 100 as a CPU substrate, a printed board 200 with a wireless LAN module mounted thereon, and a printed board 300 with a Bluetooth module mounted thereon. The main substrate 100 is connected to the printed board 200 with the wireless LAN module mounted thereon by the harness 16a passed through the through hole 15a formed in the main substrate 100. The main substrate 100 is connected to the printed board 300 with the Bluetooth module mounted thereon by the harness 16b passed through the through hole 15a formed in the main substrate 100.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

For example, in the aforementioned embodiments, the plurality of printed boards vertically superposed upon one another have been described, but a plurality of printed boards may be superposed upon one another with vertical postures in a lateral direction.

What is claimed is:

1. A printed board apparatus, comprising:
a plurality of printed boards mounted upon one another spaced by gaps,
wherein a connector is disposed on one printed board, a through hole is formed across said connector in another printed board, and a harness is passed through said through hole and connected to said connector.

2. The printed board apparatus according to claim 1, including upper and lower printed boards superposed upon each other, wherein the connector is disposed on the lower printed board, and the through hole is formed across said connector in the upper printed board.

3. The printed board apparatus according to claim 1, wherein said plurality of printed boards are vertically superposed upon one another, the connector is disposed on a lowermost printed board, and through holes are formed across said connector in a plurality of upper printed boards.

4. The printed board apparatus according to claim 1, including an upper printed board, a middle printed board, and a lower printed board, wherein the connector and the through hole are disposed on the middle printed board, a second through hole is formed across said connector in the upper printed board, and a second connector is disposed on the lower printed board, a second harness connected to the second connector is passed through the through hole, which is formed across the second connector in the middle printed board, and a third through hole formed across the through hole in the upper printed board.

5. The printed board apparatus according to claim 1, wherein a wireless module is mounted on the printed board connected to said harness.

6. The printed board apparatus according to claim 5, wherein said harness is a lead of the wireless module.

7. The printed board apparatus according to claim 1, wherein at least one of a Bluetooth module and a wireless LAN module is mounted on the printed board connected to said harness.

8. An electronic apparatus comprising:
a plurality of printed boards mounted superposed upon one another spaced by constant gaps in a housing,
wherein a connector is disposed on one printed board, a through hole is formed across said connector in another printed board, and a harness is passed through said through hole and connected to said connector.

9. The electronic apparatus according to claim 8, wherein a wireless module is mounted on the printed board connected to said harness, and a lead of said module is passed as said harness through said through hole.

10. A printed board apparatus, comprising:
a first printed board;
a connector disposed on the first printed board;
a second printed board mounted in a parallel plane to the first printed board spaced by a gap, the second printed board having a through hole formed across said connector; and
a harness connected to the connector and passed through the through hole in the second printed board.

11. The printed board apparatus according to claim 10, wherein the first printed board and the second printed board are mounted vertically upon each is other.

12. The printed board apparatus according to claim 10, wherein the first printed board and the second printed board are mounted horizontally upon each other.

13. The printed board apparatus according to claim 10, wherein the first printed board is a lower printed board and the second printed board is an upper printed board.

14. The printed board apparatus according to claim 10, further including a middle printed board, the middle printed board mounted in between the first printed board and the second printed board and spaced by gaps, the middle printed board having a second connector and a second through hole formed across said connector on the first printed board, wherein the harness passes through the second through hole in the middle printed board and through the through hole in the second printed board, and a second harness connected to the second connector passes through a third through hole formed across the second connector in the second printed board.

15. A wireless LAN apparatus, comprising:
a first printed board;
a wireless LAN module mounted on the first printed board;
a connector disposed on the first printed board;
a second printed board mounted in a parallel plane to the first printed board spaced by a gap, the second printed board having a through hole formed across said connector; and
a harness connected to the connector and passed through the through hole in the second printed board.

16. The wireless LAN apparatus according to claim 15, wherein said harness is a lead of the wireless LAN module.

17. A Bluetooth apparatus, comprising:
a first printed board;
a Bluetooth module mounted on the first printed board;
a connector disposed on the first printed board;
a second printed board mounted in a parallel plane to the first printed board spaced by a gap, the second printed board having a through hole formed across said connector; and
a harness connected to the connector and passed through the through hole in the second printed board.
